(19) United States
(12) Patent Application Publication
(10) Pub. No.: US 2019/0146827 A1
(43) Pub. Date: May 16, 2019

(54) VIRTUALIZED NETWORK FUNCTION RESOURCE MANAGEMENT METHOD AND DEVICE

(71) Applicant: HUAWEI TECHNOLOGIES CO., LTD., SHENZHEN (CN)

(72) Inventors: Fang YU, Beijing (CN); Fengzhe ZHANG, Bonn (DE); Zhan PENG, Shenzhen (CN)

(21) Appl. No.: 16/233,039

(22) Filed: Dec. 26, 2018

Related U.S. Application Data
(63) Continuation of application No. PCT/CN2016/087494, filed on Jun. 28, 2016.

(51) Int. Cl. G06F 9/455; G06F 9/50

(52) U.S. Cl. CPC G06F 9/45558; G06F 9/5077; G06F 2009/4557; G06F 2009/45579; G06F 2009/45595

(57) ABSTRACT

Embodiments of this application disclose a virtualized network function resource management method and device. The method includes: sending, by a virtual network function manager (VNFM) device, a preprocessing request message to an element manager (EM) device, where the preprocessing request message is used to request the EM device to perform a resource pre-scaling-in on a virtual network function (VNF) instance, and the resource pre-scaling-in includes migrating a service hosted in a virtualization container on which the resource pre-scaling-in needs to be performed; and performing, by the VNFM device, the resource scaling-in on the VNF instance after determining that the EM device completes the resource pre-scaling-in. According to the method and apparatus provided in the embodiments of this application, preprocessing can be performed on the virtualization container, and the service hosted in the virtualization container can be migrated to avoid being damaged during the resource scaling-in.

### CROSS-REFERENCE TO RELATED APPLICATIONS

This application is a continuation of International Patent Application No. PCT/CN2016/087494, filed on Jun. 28, 2016. The disclosure of the aforementioned application is herein incorporated by reference in the entity.

### TECHNICAL FIELD

This application relates to the communications field, and in particular, to a virtualized network function resource management method and device.

### BACKGROUND

According to a network functions virtualization (NFV) technology, some network functions may be implemented on commodity hardware by means of software. For example, in a telecommunications network, some telecommunications network functions may be implemented on a universal cloud server, a universal switch, and a universal memory by using the NFV technology, thereby implementing rapid and efficient network service deployment.

In the NFV technology, scaling-out and scaling-in of a network element are implemented through elastic scaling, that is, a related resource is dynamically allocated to or reclaimed from a virtualized network function (VNF) based on a requirement. Currently, when a scaling-in is performed, a virtualized network function manager directly scales in a to-be-scaled-in virtual machine after determining the to-be-scaled-in virtual machine, resulting in damage of services running on the virtual machine.

### SUMMARY

In view of this, embodiments of this application provide a virtualized network function resource management method and device, to prevent services hosted on a virtual machine from being damaged when a VNF performs a resource scaling-in.

According to a first aspect, a virtualized network function resource management method is provided. The method includes: sending, by a virtualized network function manager (VNFM) device, a preprocessing request message to an element manager (EM) device, where the preprocessing request message is used to request the EM device to perform a resource pre-scaling-in on a virtualized network function VNF instance, and the resource pre-scaling-in includes migrating a service hosted in a virtualization container on which the resource pre-scaling-in needs to be performed; and performing, by the VNFM device, the resource scaling-in on the VNF instance after determining that the EM device completes the resource pre-scaling-in.

In the virtualized network function resource management method in this embodiment of this application, the EM device is requested to perform preprocessing on the virtualization container on which the resource scaling-in needs to be performed in a virtualization container corresponding to the VNF instance and migrate the service hosted in the virtualization container, to avoid damaging a function of the VNF instance during the resource scaling-in.

In one embodiment, performing, by the VNFM device, the resource pre-scaling-in on the VNF instance after determining that the EM device completes the resource pre-scaling-in includes: receiving, by the VNFM device, a preprocessing acknowledgment message sent by the EM device, where the preprocessing acknowledgment message is used to notify the VNFM device that the resource pre-scaling-in has been completed; and performing, by the VNFM device, the resource pre-scaling-in on the VNF instance based on the preprocessing acknowledgment message.

In one embodiment, performing, by the VNFM device, the resource scaling-in on the VNF instance after determining that the EM device completes the resource pre-scaling-in includes: performing, by the VNFM device, the resource scaling-in on the VNF instance after a time period elapses after the VNFM device sends the preprocessing request message to the EM device. Therefore, a resource waste due to an excessively long wait time can be avoided, thereby improving resource utilization.

In one embodiment, the method further includes: before the sending, by a VNFM device, of a preprocessing request message to an EM device, receiving, by the VNFM device, a resource scaling-in request message sent by a network functions virtualization orchestrator NFVO device, where the resource scaling-in request message includes an identifier list of the virtualization container on which the resource pre-scaling-in needs to be performed, and the preprocessing request message includes the identifier list of the virtualization container.

In one embodiment, the resource scaling-in request message further includes a time parameterused to determine a time period. Performing, by the VNFM device, the resource scaling-in on the VNF instance after determining that the EM device completes the resource pre-scaling-in includes: performing, by the VNFM device, the resource scaling-in on the VNF instance after the time period elapses after the VNFM device sends the preprocessing request message to the EM device.

In one embodiment, the preprocessing request message includes an identifier list of the virtualization container on which the resource pre-scaling-in needs to be performed, and the identifier list is used to identify the virtualization container on which the resource pre-scaling-in needs to be performed.

Optionally, the method further includes: before the sending, by a VNFM device, of a preprocessing request message to an EM device, receiving, by the VNFM device, a resource scaling-in request message sent by the EM device, where the resource scaling-in request message includes identification information of a virtualization deployment unit (VDU), and the virtualization container created based on the VDU identified by the identification information include the virtualization container identified by the identifier list.

In one embodiment, the resource scaling-in request message further includes a quantity parameter or a proportion parameter, where the quantity parameter is used to indicate, to the VNFM device, a quantity of virtualization containers on which the resource pre-scaling-in needs to be performed; and the proportion parameter is used to indicate, to the VNFM device, a proportion of the virtualization container on which the resource pre-scaling-in needs to be performed in all the virtualization containers created based on the VDU identified by the identification information.

In one embodiment, the method further includes: after the receiving, by the VNFM device, of a resource scaling-in request message sent by the EM device and before sending, by the VNFM device, a preprocessing request message to an EM device, sending, by the VNFM device, a VNF life cycle management operation granting request message to an NFVO device, where the VNF life cycle management operation granting request message is used to request granting of the resource scaling-in from the NFVO device; and receiving, by the VNFM device, a VNF life cycle management operation granting response message sent by the NFVO device.

In one embodiment, the identification information includes at least one of the following information: VDU identification information of the VDU, group identification information of the VDU, and type identification information of the VDU.

According to a second aspect, a virtualized network function resource management method is provided. The method includes: receiving, by an EM device, a preprocessing request message sent by a VNFM device, where the preprocessing request message is used to request the EM device to perform a resource pre-scaling-in on a virtualized network function (VNF) instance; determining, by the EM device, a first virtualization container based on the preprocessing request message, where the first virtualization container is a virtualization container on which the resource pre-scaling-in needs to be performed in a virtualization container corresponding to the VNF instance; and migrating, by the EM device, services hosted in the first virtualization container.

In this embodiment of this application, the EM device performs, based on the preprocessing request message sent by the VNFM device, preprocessing on the virtualization container on which the resource scaling-in needs to be performed in the virtualization container corresponding to the VNF instance, and migrates the service hosted in the virtualization container, to avoid, during the resource scaling-in, damage of services hosted in the virtualization container corresponding to the VNF instance.

Optionally, the preprocessing request message further includes identification information of a virtualization deployment unit VDU; and the determining, by the EM device, of a first virtualization container based on the preprocessing request message includes: determining, by the EM device according to the identification information, the first virtualization container in one or more virtualization containers created based on the VDU identified by the identification information.

In one embodiment, the determining, by the EM device, of the first virtualization container in one or more virtualization containers created based on the VDU identified by the identification information includes: determining, by the EM device based on a service volume of services hosted in the virtualization container and/or importance of the service hosted in the virtualization container, the first virtualization container in the virtualization container created based on the VDU identified by the identification information.

Optionally, the preprocessing request message further includes a quantity parameter or a proportion parameter, where the quantity parameter is used to indicate, to the EM device, a quantity of virtualization containers on which the resource pre-scaling-in needs to be performed; and the proportion parameter is used to indicate, to the EM device, a proportion of the virtualization container on which the resource pre-scaling-in needs to be performed in all the virtualization containers created based on the VDU identified by the identification information.

In one embodiment, the preprocessing request message further includes an identifier list of the virtualization container on which the resource pre-scaling-in needs to be performed; and the determining, by the EM device, of a first virtualization container based on the preprocessing request message includes: determining, by the EM device, that the virtualization container identified by the identifier list is the first virtualization container.

In one embodiment, before the receiving, by an EM device, of a preprocessing request message sent by a VNFM device, the method further includes: sending, by the EM device, a resource scaling-in request message to the VNFM device, where the resource scaling-in request message includes identification information of a VDU, and a virtualization container created based on the VDU identified by the identification information includes the virtualization container identified by the identifier list.

In one embodiment, the resource scaling-in request message further includes a quantity parameter or a proportion parameter, where the quantity parameter is used to indicate, to the EM device, a quantity of virtualization containers on which the resource pre-scaling-in needs to be performed; and the proportion parameter is used to indicate, to the EM device, a proportion of the virtualization container on which the resource pre-scaling-in needs to be performed in all the virtualization containers created based on the VDU indicated by the identification information.

In one embodiment, the identification information of the VDU includes at least one of the following information: VDU identification information of the VDU, group identification information of the VDU, and type identification information of the VDU.

In one embodiment, after the migrating, by the EM device, of services hosted in the first virtualization container, the method further includes: sending, by the EM device, a preprocessing acknowledgment message to the VNFM device, where the preprocessing acknowledgment message is used to notify the VNFM device that the resource pre-scaling-in has been completed.

According to a third aspect, a virtualized network function resource management method is provided. The method includes: determining, by a network functions virtualization orchestrator NFVO device, an identifier list of a virtualization container on which a resource pre-scaling-in needs to be performed in the virtualization container corresponding to a virtualized network function VNF instance; and sending, by the NFVO device, the identifier list to a VNFM device, so that the VNFM device requests an EM device to perform the resource pre-scaling-in on the virtualization container identified by the identifier list.

In this embodiment of this application, the NFVO device may determine the virtualization container on which the resource scaling-in needs to be performed, for example, may determine that a virtualization container carrying relatively few services is the virtualization container on which the resource scaling-in needs to be performed, and send the identifier list of the virtualization container to the VNFM device, so that the VNFM device requests the EM device to perform the resource pre-scaling-in on the virtualization container in the identifier list, to avoid, during the resource scaling-in, damage of services hosted in the virtualization container corresponding to the VNF instance.

In one embodiment, the method further includes: before the determining, by an NFVO device, of an identifier list, receiving, by the NFVO device, a VNF life cycle management operation granting request message sent by the VNFM device, where the VNF life cycle management operation granting request message is used to request granting of the resource scaling-in from the NFVO device, and the resource scaling-in is performed by the VNFM device on the virtualization container corresponding to the VNF instance; and sending, by the NFVO device, a VNF life cycle management operation granting response message to the VNFM device based on the VNF life cycle management operation granting request message, where the VNF life cycle management operation granting response message is used for the granting of the resource scaling-in; and the sending, by the NFVO device, of the identifier list to a VNFM device includes: sending, by the NFVO device, the VNF life cycle management operation granting response message including the identifier list to the VNFM device.

In one embodiment, the method further includes: after the determining, by an NFVO device, of an identifier list, sending, by the NFVO device, a resource scaling-in request message to the VNFM device, where the resource scaling-in request message is used to request the VNFM device to perform the resource scaling-in on the virtualization container corresponding to the VNF instance; and the sending, by the NFVO device, of the identifier list to the VNFM device includes: sending, by the NFVO device, the resource scaling-in request message including the identifier list to the VNFM device.

In one embodiment, the resource scaling-in request message further includes a time parameter that is used to instruct the VNFM device to perform, after the VNFM device sends the preprocessing request message to the EM device and after a time period indicated by the time parameter, the resource scaling-in on the virtualization container corresponding to the VNF instance.

According to a fourth aspect, a virtualized network function resource management device is provided. The device includes:

an input/output device, configured to send a preprocessing request message to an element manager element manager device, where the preprocessing request message is used to request the EM device to perform a resource pre-scaling-in on a virtualized network function VNF instance, and the resource pre-scaling-in includes a migrating service hosted in a virtualization container on which the resource pre-scaling-in needs to be performed; and

a processor, configured to perform the resource scaling-in on the VNF instance after determining that the EM device completes the resource pre-scaling-in.

In the VNF resource management device in this embodiment of this application, the EM device is requested to perform preprocessing on the virtualization container on which the resource scaling-in needs to be performed in a virtualization container corresponding to the VNF instance and migrate the service hosted in the virtualization container, to avoid damage of a function of the VNF instance during the resource scaling-in.

In one embodiment, the input/output device is further configured to receive a preprocessing acknowledgment message sent by the EM device, where the preprocessing acknowledgment message is used to notify the VNFM device that the resource pre-scaling-in has been completed; and the processor is further configured to perform the resource pre-scaling-in on the VNF instance based on the preprocessing acknowledgment message received by the input/output device.

In one embodiment, the processor is further configured to perform the resource scaling-in on the VNF instance after a time period elapses after the input/output device sends the preprocessing request message to the EM device.

In one embodiment, the input/output device is further configured to receive a resource scaling-in request message sent by a network functions virtualization orchestrator NFVO device, where the resource scaling-in request message includes an identifier list of the virtualization container on which the resource pre-scaling-in needs to be performed, and the preprocessing request message includes the identifier list of the virtualization container.

In one embodiment, the resource scaling-in request message further includes a time parameter, and the time parameter is used to determine a time period; and the processor is further configured to perform the resource scaling-in on the VNF instance after the time period elapses after the input/output device sends the preprocessing request message to the EM device.

In one embodiment, the preprocessing request message includes an identifier list of the virtualization container on which the resource pre-scaling-in needs to be performed, and the identifier list is used to identify the virtualization container on which the resource pre-scaling-in needs to be performed.

In one embodiment, the input/output device is further configured to receive a resource scaling-in request message sent by the EM device, where the resource scaling-in request message includes identification information of a virtualization deployment unit VDU, and a virtualization container created based on the VDU identified by the identification information include the virtualization container identified by the identifier list.

In one embodiment, the resource scaling-in request message further includes a quantity parameter or a proportion parameter, where the quantity parameter is used to indicate, to the processor, a quantity of virtualization containers on which the resource pre-scaling-in needs to be performed; and the proportion parameter is used to indicate, to the processor, a proportion of the virtualization container on which the resource pre-scaling-in needs to be performed in all the virtualization containers created based on the VDU identified by the identification information.

In one embodiment, the input/output device is further configured to send a VNF life cycle management operation granting request message to the NFVO device, where the VNF life cycle management operation granting request message is used to request granting of the resource scaling-in from the NFVO device; and receive a VNF life cycle management operation granting response message sent by the NFVO device.

In one embodiment, the identification information includes at least one of the following information: VDU identification information of the VDU, group identification information of the VDU, and type identification information of the VDU.

According to a fifth aspect, a virtualized network function resource management device is provided. The device includes:

an input/output device, configured to receive a preprocessing request message sent by a VNFM device, where the preprocessing request message is used to request the device to perform a resource pre-scaling-in on a virtualized network function VNF instance; and

a processor, configured to determine a first virtualization container based on the preprocessing request message received by the input/output device, where the first virtualization container is a virtualization container on which the resource pre-scaling-in needs to be performed in a virtualization container corresponding to the VNF instance.

The processor is further configured to migrate services hosted in the first virtualization container.

In the VNF resource management device in this embodiment of this application, preprocessing is performed, based on the preprocessing request message sent by the VNFM device, on the virtualization container on which the resource scaling-in needs to be performed in the virtualization container corresponding to the VNF instance, and the service hosted in the virtualization container is migrated, to avoid damage of a function of the VNF instance during the resource scaling-in.

In one embodiment, the preprocessing request message further includes identification information of a virtualization deployment unit VDU, and the processor is further configured to determine, according to the identification information, the first virtualization container in one or more virtualization containers created based on the VDU identified by the identification information.

In one embodiment, the processor is further configured to determine, based on a service volume of services hosted in the virtualization container and/or importance of the service hosted in the virtualization container, the first virtualization container in the virtualization container created based on the VDU identified by the identification information.

In one embodiment, the preprocessing request message further includes a quantity parameter or a proportion parameter, where the quantity parameter is used to indicate, to the processor, a quantity of virtualization containers on which the resource pre-scaling-in needs to be performed; and the proportion parameter is used to indicate, to the processor, a proportion of the virtualization container on which the resource pre-scaling-in needs to be performed in all the virtualization containers created based on the VDU identified by the identification information.

In one embodiment, the preprocessing request message further includes an identifier list of the virtualization container on which the resource pre-scaling-in needs to be performed, and the processor is further configured to determine that the virtualization container identified by the identifier list is the first virtualization container.

In one embodiment, the input/output device is further configured to send a resource scaling-in request message to the VNFM device, where the resource scaling-in request message includes identification information of a VDU, and a virtualization container created based on the VDU identified by the identification information includes the virtualization container identified by the identifier list.

In one embodiment, the resource scaling-in request message further includes a quantity parameter or a proportion parameter, where the quantity parameter is used to indicate, to the VNFM device, a quantity of virtualization containers on which the resource pre-scaling-in needs to be performed; and the proportion parameter is used to indicate, to the VNFM device, a proportion of the virtualization container on which the resource pre-scaling-in needs to be performed in all the virtualization containers created based on the VDU indicated by the identification information.

In one embodiment, the identification information of the VDU includes at least one of the following information: VDU identification information of the VDU, group identification information of the VDU, and type identification information of the VDU.

In one embodiment, the input/output device is further configured to send a preprocessing acknowledgment message sent by the VNFM device, where the preprocessing acknowledgment message is used to notify the VNFM device that the resource pre-scaling-in has been completed.

According to a sixth aspect, a virtualized network function resource management device is provided. The device includes:

a processor, configured to determine an identifier list of a virtualization container on which a resource pre-scaling-in needs to be performed in a virtualization container corresponding to a virtualized network function VNF instance; and

an input/output device, configured to send, to a VNFM device, the identifier list determined by the processor, so that the VNFM device requests an EM device to perform a resource pre-scaling-in on the virtualization container identified by the identifier list.

In this embodiment of this application, the virtualized network function resource management device may determine the virtualization container on which the resource scaling-in needs to be performed, for example, may determine that a virtualization container carrying relatively few services is the virtualization container on which the resource scaling-in needs to be performed, and send the identifier list of the virtualization container to the VNFM device, so that the VNFM device requests the EM device to perform the resource pre-scaling-in on the virtualization container in the identifier list, to avoid, during the resource scaling-in, damage of services hosted in the virtualization container corresponding to the VNF instance.

In one embodiment, the input/output device is further configured to: receive a VNF life cycle management operation granting request message set by the VNFM device, where the VNF life cycle management operation granting request message is used to request granting of resource scaling-in from the processor, and the resource scaling-in is resource scaling-in performed by the VNFM device on the virtualization container corresponding to the VNF instance; and send a VNF life cycle management operation granting response message to the VNFM device, where the VNF life cycle management operation granting response message is used for the granting of the resource scaling-in.

The input/output device is further configured to send the VNF life cycle management operation granting response message including the identifier list to the VNFM device.

In one embodiment, the input/output device is further configured to send a resource scaling-in request message to the VNFM device, where the resource scaling-in request message is used to request the VNFM device to perform a resource scaling-in on the virtualization container corresponding to the VNF instance.

The input/output device is further configured to send the resource scaling-in request message including the identifier list to the VNFM device.

In one embodiment, the resource scaling-in request message further includes a time parameter, and the time parameter is used to instruct the VNFM device to perform, after the VNFM device sends the preprocessing request message to the EM device and after a time period indicated by the time parameter, the resource scaling-in on the virtualization container corresponding to the VNF instance.

According to a seventh aspect, a computer program product is provided. The computer program product includes computer program code, and when the computer program code is run by a transceiver unit and a processing unit or a transceiver and a processor that are of a controller configured in an adapter, the controller is enabled to perform any virtualized network function resource management method according to the first aspect and various implementations of the first aspect.

According to an eighth aspect, a computer program product is provided. The computer program product includes computer program code, and when the computer program code is run by a transceiver unit and a processing unit or a transceiver and a processor that are of a controller configured in an adapter, the controller is enabled to perform any virtualized network function resource management method according to the second aspect and various implementations of the second aspect.

According to a ninth aspect, a computer program product is provided. The computer program product includes computer program code, and when the computer program code is run by a transceiver unit and a processing unit or a transceiver and a processor that are of a controller configured in an adapter, the controller is enabled to perform any virtualized network function resource management method according to the third aspect and various implementations of the third aspect.

According to a tenth aspect, a computer-readable storage medium is provided. The computer-readable storage medium stores a program, and the program enables a controller configured in an adapter to perform any virtualized network function resource management method according to the first aspect and various implementations of the first aspect.

According to an eleventh aspect, a computer-readable storage medium is provided. The computer-readable storage medium stores a program, and the program enables a controller configured in an adapter to perform any virtualized network function resource management method according to the second aspect and various implementations of the second aspect.

According to a twelfth aspect, a computer-readable storage medium is provided. The computer-readable storage medium stores a program, and the program enables a controller configured in an adapter to perform any virtualized network function resource management method according to the third aspect and various implementations of the third aspect.

### BRIEF DESCRIPTION OF DRAWINGS

To describe the technical solutions in the embodiments of this application more clearly, the following briefly describes the accompanying drawings required for describing the embodiments. Apparently, the accompanying drawings in the following description show merely some embodiments of this application, and a person of ordinary skill in the art may derive other drawings from these accompanying drawings without creative efforts.

FIG. 1 is a schematic diagram of an application scenario to which an embodiment of this application is applied;

FIG. 2 is a schematic interaction diagram of a virtualized network function resource management method according to an embodiment of this application;

FIG. 3 is a schematic interaction diagram of a virtualized network function resource management method according to another embodiment of this application;

FIG. 4 is a schematic interaction diagram of a virtualized network function resource management method according to still another embodiment of this application;

FIG. 5 is a schematic interaction diagram of a virtualized network function resource management method according to still another embodiment of this application;

FIG. 6 is a schematic interaction diagram of a virtualized network function resource management method according to still another embodiment of this application;

FIG. 7 is a schematic interaction diagram of a virtualized network function resource management method according to still another embodiment of this application;

FIG. 8 is a schematic block diagram of a virtualized network function resource management device according to an embodiment of this application;

FIG. 9 is a schematic block diagram of a virtualized network function resource management device according to another embodiment of this application; and

FIG. 10 is a schematic block diagram of a virtualized network function resource management device according to still another embodiment of this application.

### DESCRIPTION OF EMBODIMENTS

For ease of understanding the embodiments of this application, several elements used in the embodiments of this application are first described herein.

A virtualization container is a part of a computing node, and is configured to provide an isolated virtualized computing environment. A typical example of the virtualization container is a virtual machine. A virtual machine (VM) refers to a virtual device simulated on a physical device by using virtual machine software. For an application program running in a virtual machine, the virtual machine works as a real physical device. An operating system and an application program may be installed on the virtual machine, and the virtual machine may further access a network resource.

A virtualized network function (VNF) may also be referred to as a virtualized network element, and corresponds to a physical network function in a conventional non-virtualized network. A functional behavior and a status of a network function are unrelated to virtualization of the network function. The VNF may include a plurality of lower-level components. Optionally, one VNF may be deployed on a plurality of VMs, and each VM hosts one VNF component (VNFC). Optionally, one VNF may alternatively be deployed on one VM.

A virtualized network function descriptor (VNFD) is a deployment template of the VNF. Optionally, the VNFD and the VNF are in a one-to-one correspondence. The VNFD describes a virtual resource parameter and requirement that are required for implementing the VNF, and is mainly used to set up a VNF instance and manage a life cycle of the VNF.

A virtualization deployment unit (VDU) is an important component of the VNFD, and is used to describe a behavior and a requirement in deployment and operation of the VNFC. The deployment includes a resource requirement and a resource restriction, and the operation includes a software image. A VNFC instance is created based on the VDU.

A virtualized network function manager (VNFM) is configured to implement life cycle management of the VNF, including management and processing of the VNFD, initialization of the VNF instance, scaling-out or scaling-in of the VNF, and termination of the VNF instance. The VNFM is further configured to receive and execute a elastic scaling policy delivered by a higher layer, to implement elastic scaling of the VNF.

An element manager performs conventional FCAPS (Fault Management, Configuration Management, Accounting Management, Performance Management and Security Management, fault management, configuration management, accounting management, performance management and security management) functions for the VNF. An EM module may exist alone, or may be a VNF having an EM function.

A network functions virtualization orchestrator (NFVO) is used for life cycle management of a network service, and cooperates with the VNFM to implement the life cycle management of the VNF and a global view function of a resource.

Scaling-outt/Scaling-in operation: The VNFM scales out or scales in a resource instance, that is, scales out or scales in a VM corresponding to the VDU, to implement elastic scaling of a resource.

Scaling up/down operation: The VNFM changes a resource allocated to a single resource instance, for example, scales up or scales down a capability of a memory, storage, or CPU (central processing unit) of the VM, to implement elastic scaling of the resource.

A method in the embodiments of this application may further be applied to an application container engine Docker architecture or another virtualized architecture in addition to a virtual machine architecture. Therefore, the following virtualization container may refer to a virtual machine in a hypervisor-based virtualization technology or a Docker container in a container-based virtualization technology.

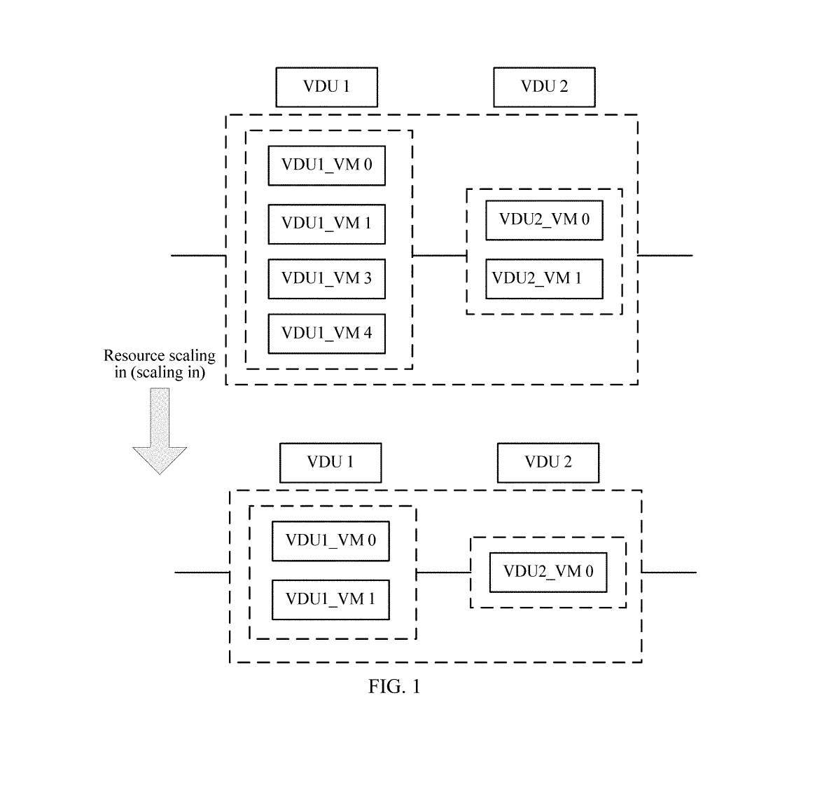

FIG. 1 is a schematic diagram of an application scenario to which an embodiment of this application is applied. A VDU is essentially a virtual resource requirement template, and VMs instantiated based on different VDUs provide different services. There is an association between VDUs providing a same type of service. As shown in FIG. 1, a VDU 1 and a VDU 2 are respectively VDUs having a forwarding function. The VDU 1 corresponds to four VMs (that is, a VDU1_VM 0, a VDU1_VM 1, a VDU1_VM 3, and a VDU1_VM 4), and the VDU 2 corresponds to two VMs (that is, a VDU2_VM 0 and a VDU2_VM 1). When a scaling-in operation is performed on the VDU 1, a scaling-in operation also needs to be performed on the VDU 2. Otherwise, resources of the VMs corresponding to the VDU 2 are wasted.

When the scaling-in operation is performed on the VDU 2, services in a to-be-scaled-in VM first need to be transferred to another virtual machine, for example, services in the to-be-scaled-in VDU2_VM 1 are migrated to the VDU2_VM 0, and then the VDU2_VM 1 is scaled in. In this way, it can be ensured that the service hosted in the VDU 2 are undamaged during the resource scaling-in.

In addition, a quantity of VMs needing to be scaled in from the VDU 2 is also associated with a quantity of VMs scaled in from the VDU 1. For example, when two VMs (that is, the VDU1_VM 3 and the VDU1_VM 4) need to be scaled in from the VDU 1, one VM (that is, the VDU2_VM 1) also needs to be scaled in from the VDU 2.

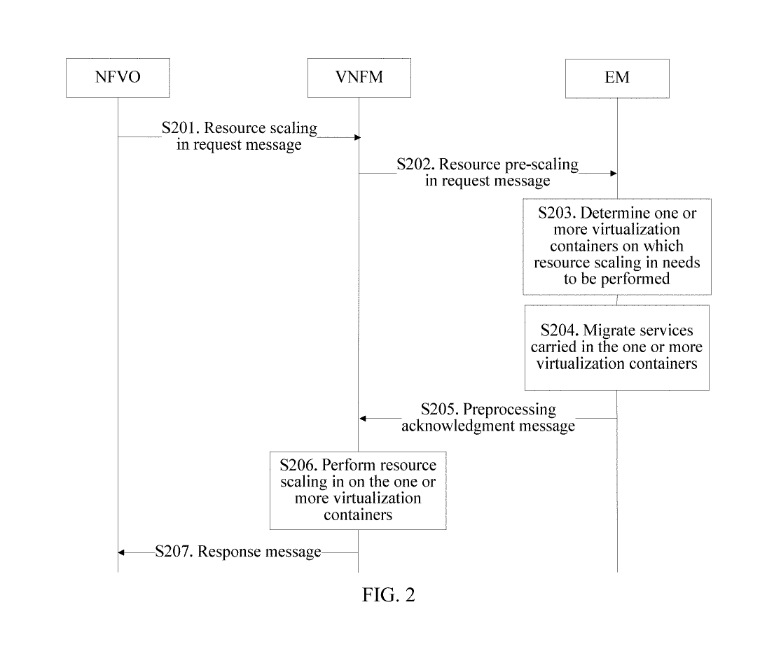

A virtualized network function resource management method according to the embodiments of this application is described in detail below with reference to FIG. 2 to FIG. 4.

FIG. 2 is a schematic diagram of a VNF resource management method according to an embodiment of this application. As shown in FIG. 2, the method 200 in this embodiment includes the following steps.

In operation S201 an NFVO device sends a resource scaling-in request message (e.g., a VNF scaling-in request) to a VNFM device, to request to perform a resource scaling-in operation on a VNF instance. A resource scaling-in parameter carried in the resource scaling-in request message includes an identifier (vnfInstanceId) of the VNF instance, and may further include one or more of the following parameters: a proportion parameter (scaleStep), a time parameter (timeout), and identification information of a VDU, and the identification information of the VDU includes at least one of a VDU identifier (vduId) of the VDU, a group identifier (vduGroupId) of the VDU, and a type identifier (vduTypeId) of the VDU.

The proportion parameter is used to indicate, in one or more virtualization containers created based on a single VDU, a proportion of one or more virtualization containers on which the resource pre-scaling-in needs to be performed in all the one or more virtualization containers created based on the single VDU. For example, current resource scaling-in is performed based on a VDU type, and it may be designated that in one or more virtualization containers created based on each VDU in the VDU type, a quantity of virtualization containers on which the resource pre-scaling-in is to be performed needs to account for x % of a total quantity of the one or more virtualization containers created based on each VDU, where x is a natural number greater than 0. The resource scaling-in request message may further include a quantity parameter, and a quantity of virtualization containers on which the resource scaling-in needs to be performed in one or more virtualization containers corresponding to the VNF instance is directly indicated to the VNFM device by using the quantity parameter. Therefore, the quantity of virtualization containers on which the resource scaling-in needs to be performed can be flexibly determined based on an actual case.

The time parameter is used to determine a time period. After the VNFM device sends the preprocessing request message to the EM device and after the time period, the VNFM device performs a resource scaling-in on the VNF instance. If not receiving a preprocessing acknowledgment message within the time period, the VNFM device may send a resource scaling-in error message to the NFVO device, or may directly request a virtualized infrastructure manager (VIM) device to release a resource used by a virtualization container, to avoid a resource waste due to an excessively long wait time, thereby improving resource utilization. The virtualization container may be a virtualization container that is determined by the VNFM device and that hosts relatively few services or hosts unimportant services in the VNF instance, or may be a virtualization container determined by the VNFM device according to indication information of the NFVO device. The foregoing embodiment is merely an example for description, and this embodiment of this application is not limited thereto.

The VDU may be grouped or classified in different dimensions based on a deployment requirement, and a VDU group to which the VDU belongs may be indicated in a VNFD, or a type to which the VDU belongs is indicated in the VNFD. Alternatively, the VDU may be grouped and classified together. Optionally, the VDU may be grouped or classified in terms of a service type supported by the VDU, dependency, or an active-standby relationship. During the resource scaling-in, a granularity (that is, the VDU, the VDU group, or the VDU type) on which processing is based may be indicated, to flexibly determine, based on an actual case, the virtualization container on which the resource scaling-in needs to be performed.

A VDU group to which each VDU belongs includes at least two VDUs whose VDU identifiers are different. Alternatively, a VDU type to which each VDU belongs also includes at least two VDUs whose VDU identifiers are different. Optionally, each VDU can belong to only one VDU group or VDU type at most.

For example, a VDU group identifier attribute may be added to an information element (IE) description of the VDU, to describe an identifier of the VDU group to which the VDU belongs. As shown in Table 1, a VDU identifier is a mandatory attribute, and a VDU group identifier is an optional attribute. When the IE description of the VDU does not include the attribute or a value of the VDU group identifier attribute is null (that is, a cardinality is 0), it indicates that the VDU does not belong to any VDU group. As shown in Table 2, an IE of VDU group information may alternatively be added to the VNFD. The IE may include the VDU group identifier attribute and a VDU list (vduList) attribute. A VDU list is used to indicate a VDU included in a VDU group. As shown in Table 3, an attribute type (vduType) may further be added to the IE of the VDU, to describe the type to which the VDU belongs, so that when performing a VNF resource scaling-in operation, the VNFM performs a resource scaling-in operation on a type of VDUs as a group of VDUs.

TABLE 1

| Attribute | Qualifier | Cardinality | Data type | Description |
|---|---|---|---|---|
| (Attribute) | (Qualifier) | (Cardinality) | (Content) | (Description) |
| VDU | Mandatory | 1 | Identifier | Identifier or name |
| identifier | attribute | | (Identifier) | of a VDU, unique |
| (vduId) | (M) | | | in a VNFD |
| VDU group | Optional | 0 or 1 | Character | Identifier or name |
| identifier | attribute | | string | of a VDU group |
| (vduGroupId) | (O) | | (String) | in which the |
| | | | | VDU is located, |
| | | | | unique in the |
| | | | | VNFD |

TABLE 2

| Attribute | Qualifier | Cardinality | Data type | Description |
|---|---|---|---|---|
| (Attribute) | (Qualifier) | (Cardinality) | (Content) | (Description) |
| VDU | Mandatory | 1 | Identifier | Identifier or name |
| identifier | attribute | | (Identifier) | of a VDU, unique |
| (vduId) | (M) | | | in a VNFD |
| VDU group | Mandatory | 1 | Character | Identifier or name |
| identifier | attribute | | string | of a VDU group |
| (vduGroupId) | (M) | | (String) | in which the |
| | | | | VDU is located, |
| | | | | unique in the |
| | | | | VNFD |
| VDU list | Mandatory | 1 | Boolean | Identifier list of |
| (vduList) | attribute | | (Bool) | one or more |
| | (M) | | | VDUs included in |
| | | | | the VDU group |

TABLE 3

| Attribute | Qualifier | Cardinality | Data type | Description |
|---|---|---|---|---|
| (Attribute) | (Qualifier) | (Cardinality) | (Content) | (Description) |
| VDU | Mandatory | 1 | Identifier | Identifier or name |
| identifier | attribute | | (Identifier) | of a VDU, unique |
| (vduId) | (M) | | | in a VNFD |
| VDU type | Optional | 0 or 1 | Character | Used to indicate a |
| (vduType) | attribute | | string | type to which the |
| | (O) | | (String) | VDU belongs |

The foregoing embodiment is merely an example for description, and this embodiment of this application is not limited thereto. Any method for performing a resource scaling-in on a VDU group or type based on a requirement belongs to the protection scope of this application. For example, the VDU group attribute and the VDU type attribute may be both added to the IE of the VDU.

In operation S202, after receiving the resource scaling-in request message, the VNFM device sends a resource pre-scaling-in request message (e.g., a VNF pre-scaling-in request) to an EM device. The resource pre-scaling-in request message may include the identifier (vnfInstanceId) of the VNF instance, and may further include one or more of the following parameters: the proportion parameter (scaleStep) and the identification information of the VDU.

The resource pre-scaling-in request message is used to request the EM device to perform a resource pre-scaling-in on the VNF instance indicated by the identifier of the VNF instance, and migrate services hosted in one or more virtualization containers corresponding to the VNF instance. The proportion parameter is used to indicate, in one or more virtualization containers created based on a single VDU, a proportion of one or more virtualization containers on which the resource pre-scaling-in needs to be performed in all the one or more virtualization containers created based on the single VDU. The identification information of the VDU indicates a granularity of preprocessing performed by the EM device (that is, performing preprocessing on one or more virtualization containers created based on the VDU, a VDU group, or a VDU type). Optionally, for the proportion parameter (scaleStep) and the identification information of the VDU in S202, refer to the content in S201.

In operation S203, the EM device determines, based on the resource scaling-in request message, one or more virtualization containers on which the resource pre-scaling-in needs to be performed.

In one embodiment, the EM device may determine, based on the group identifier of the VDU, that a virtualization containers hosting relatively few services in one or more virtualization containers created based on a group to which the VDU belongs is a first virtualization container (that is, the virtualization container on which the resource pre-scaling-in needs to be performed), may determine that a virtualization container hosting unimportant services is a first virtualization container, or may determine that a virtualization container hosting unimportant services in virtualization containers hosting relatively few services is a first virtualization container.

In this application, the first virtualization container is used to clearly and briefly describe technical content rather than indicate a sequence.

S204. Migrate services hosting in the first virtualization container.

Migrating services hosting in a virtualization container belongs to the prior art, and details are not described herein.

In operation S205, the EM device sends a preprocessing (pre-scale) acknowledgment message to the VNFM device. The preprocessing acknowledgment message carries an identifier list (IdList) of the one or more virtualization containers on which the preprocessing has been completed, to notify the VNFM device that a resource occupied by the corresponding one or more virtualization containers in the identifier list and a resource of a related virtual link can be released.

S206. The VNFM device requests, based on the preprocessing acknowledgment message, a VIM device to release the resource occupied by the one or more virtualization containers and the resource of the related virtual link. If not receiving the preprocessing acknowledgment message within a longest wait time stipulated by the time parameter, the VNFM device may send a resource scaling-in operation error message to the NFVO device, or directly request the VIM device to release a resource occupied by the VNF instance (that is, perform a resource scaling-in on the VNF instance).

In operation S207, the VNFM device sends a response message (response) to the NFVO device, to notify the NFVO device of a result of the resource scaling-in.

In one embodiment, in the method 200, the proportion parameter, the quantity parameter, the identification information of the VDU, and the time parameter may alternatively be defined in the VNFD. The EM device may read the VNFD to obtain the foregoing parameters without adding the foregoing parameters to the request message, to reduce overheads of system signaling. The EM device may alternatively be a VNF device having an element management function.

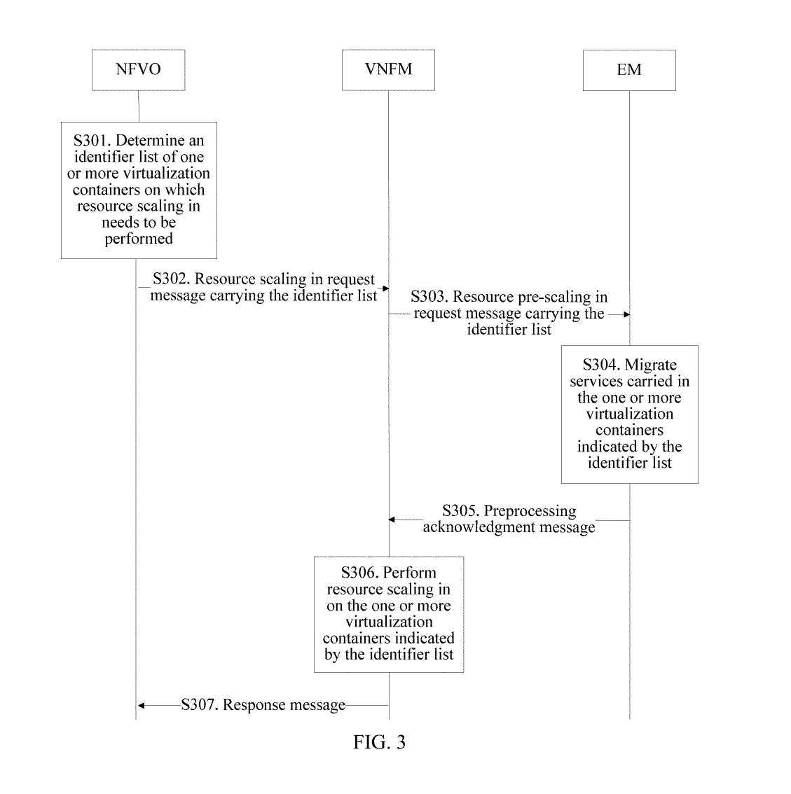

FIG. 3 is a schematic diagram of a VNF resource management method according to another embodiment of this application. For content in this embodiment the same as that in the embodiment in FIG. 2, refer to a corresponding part in the embodiment in FIG. 2, and details are not described herein again. As shown in FIG. 3, the method 300 in this embodiment includes the following steps.

In operation S301, at an NFVO device determines an identifier list (IdList) of one or more virtualization containers on which the resource scaling-in needs to be performed.

The NFVO device may determine, according to identification information of a VDU, a first virtualization container (that is, the virtualization container on which the resource scaling-in needs to be performed) in one or more virtualization containers created based on the VDU. A method for determining the first virtualization container is the same as a method for determining the first virtualization container by the EM device in the method 200. The NFVO device generates the identifier list after determining the first virtualization container.

In operation S302, the NFVO device sends a resource scaling-in request message (e.g., a VNF scaling-in request) to a VNFM device, to request to perform a resource scaling-in on a VNF instance. A resource scaling-in parameter carried in the resource scaling-in request message may include an identifier (vnfInstanceId) of the VNF instance and the identifier list determined by the NFVO device in S301, and the identifier list is used to identify a first virtualization container on which the resource pre-scaling-in needs to be performed. The resource scaling-in request message may further include one or more of the following parameters: a proportion parameter (scaleStep), a time parameter (timeout), and identification information of a VDU, where the identification information of the VDU includes at least one of a VDU identifier (vduId) of the VDU, a group identifier (vduGroupId) of the VDU, and a type identifier (vduTypeId) of the VDU.

In operation S303, after receiving the resource scaling-in request message, the VNFM device sends a resource pre-scaling-in request message (VNF pre-scaling-in request) to an EM device. The resource pre-scaling-in request message includes the identifier (vnfInstanceId) of the VNF instance and the identifier list.

In operation S304, the element manager device migrates, based on the resource pre-scaling-in request message, services hosted in the first virtualization container.

Specifically, the EM device determines, based on the identifier list, the first virtualization container on which the resource pre-scaling-in needs to be performed. Migrating services hosted in a virtualization container belongs to the prior art, and details are not described herein.

In operation S305, the EM device sends a preprocessing (pre-scale) acknowledgment message to the VNFM device, to notify the VNFM device that a resource occupied by the first virtualization container and a resource of a virtual link can be released.

In operation S306, the VNFM device requests, based on the preprocessing acknowledgment message, a VIM device to release the resource occupied by the first virtualization container and the resource of the related virtual link. If not receiving the preprocessing acknowledgment message within a longest wait time stipulated by the time parameter, the VNFM device may send a resource scaling-in operation error message to the NFVO device; or determine a to-be-released virtualization container according to a rule, for example, designate a virtualization container carrying relatively few services as a virtualization container whose resource needs to be released, and directly request the VIM device to release the resource.

In operation S307, the VNFM device sends a response message (response) to the NFVO device, to notify a result of the resource scaling-in.

In one embodiment, in the method 300, the time parameter may alternatively be defined in a VNFD. The NFVO device may read the VNFD to obtain the foregoing parameter without adding the foregoing parameter to the request message, to reduce overheads of system signaling. The EM device may alternatively be a VNF device having an element management function.

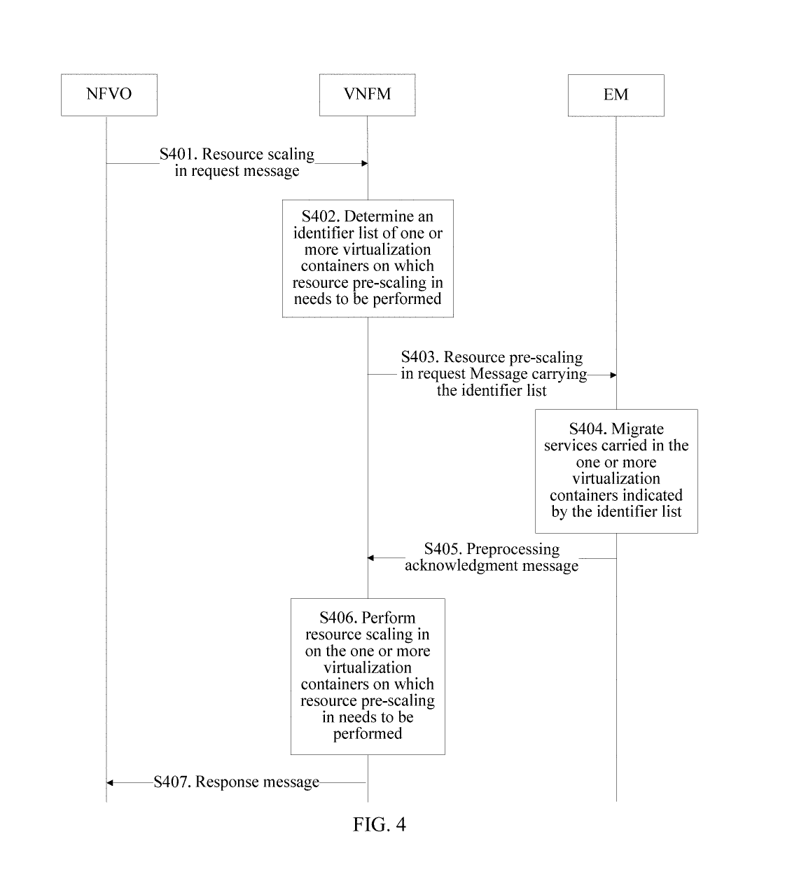

FIG. 4 is a schematic diagram of a VNF resource management method according to still another embodiment of this application. For content in this embodiment the same as those in the embodiments in FIG. 2 and FIG. 3, refer to corresponding parts in the embodiments in FIG. 2 and FIG. 3, and details are not described herein again. As shown in FIG. 4, the method 400 in this embodiment includes the following steps.

In operation S401, an NFVO device sends a resource scaling-in request message (e.g., a VNF scaling-in request) to a VNFM device, to request to perform a resource scaling-in operation on a VNF instance. A resource scaling-in parameter carried in the resource scaling-in request message includes an identifier (vnfInstanceId) of the VNF instance, and may further include one or more of the following parameters: a proportion parameter (scaleStep), a time parameter (timeout), and identification information of a VDU, and the identification information of the VDU includes at least one of a VDU identifier (vduId) of the VDU, a group identifier (vduGroupId) of the VDU, and a type identifier (vduTypeId) of the VDU.

In operation S402, after receiving the resource scaling-in request message, the VNFM device determines an identifier list (IdList) of one or more virtualization containers on which the resource pre-scaling-in needs to be performed, where the VNFM device may determine, according to the identification information of the VDU, a first virtualization container (that is, virtualization container on which the resource scaling-in needs to be performed) in one or more virtualization containers created based on the VDU. A method for determining the first virtualization container is the same as a method for determining the first virtualization container by the EM device in the method 200, and the VNFM device generates the identifier list after determining the first virtualization container.

In operation S403, the VNFM device sends a resource pre-scaling-in request message (e.g., a VNF pre-scaling-in request) to an EM device. The resource pre-scaling-in request message carries the identifier (vnfInstanceId) of the VNF instance and the identifier list.

In operation S404, the element manager device migrates, based on the resource pre-scaling-in request message, services hosted in the first virtualization container.

In operation S405, the EM device sends a preprocessing (pre-scale) acknowledgment message to the VNFM device, to notify the VNFM device that a resource occupied by the first virtualization container and a resource of a virtual link can be released.

In operation S406, the VNFM device requests, based on the preprocessing acknowledgment message, a VIM device to release the resource occupied by the first virtualization container and the resource of the related virtual link. If not receiving the preprocessing acknowledgment message within a longest wait time stipulated by a the time parameter, the VNFM device may send a resource scaling-in operation error message to the NFVO device, or directly request the VIM device to release the resources.

In operation S407, the VNFM device sends a response message (response) to the NFVO device, to notify a result of the resource scaling-in.

In one embodiment, in the method 400, the proportion parameter, the identification information of the VDU, and the time parameter may alternatively be defined in a VNFD. The VNFM device may read the VNFD to obtain the foregoing parameters without adding the foregoing parameters to the request message, to reduce overheads of system signaling. The EM device may alternatively be a VNF device having an element management function.

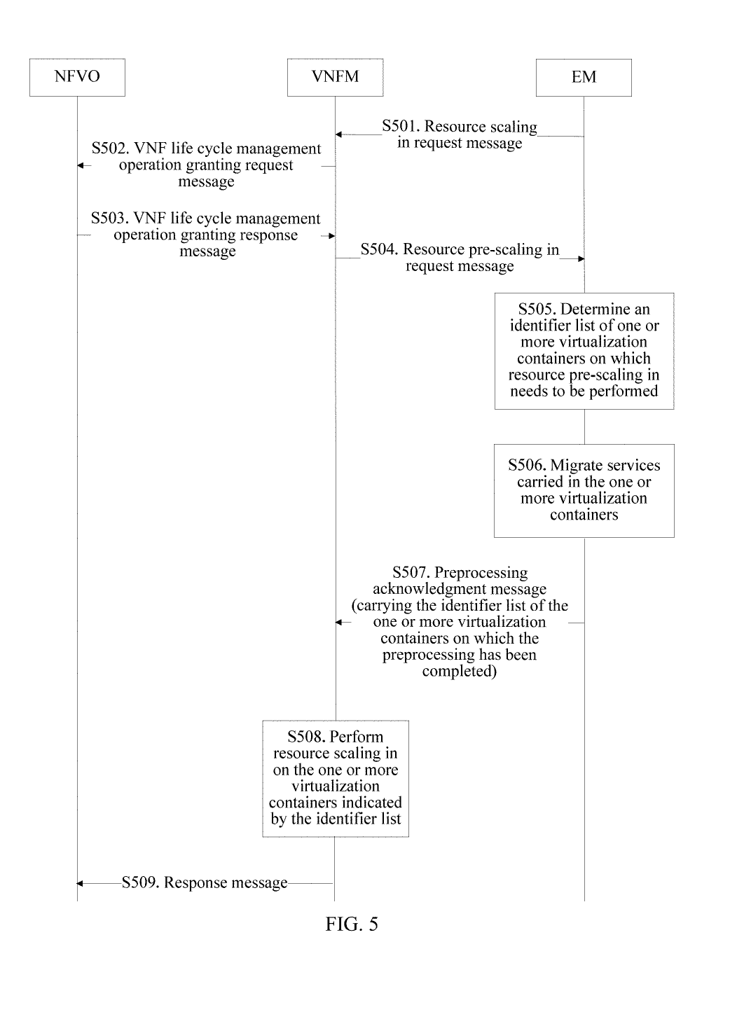

FIG. 5 is a schematic diagram of a VNF resource management method according to still another embodiment of this application. For content in this embodiment the same as those in the embodiments in FIG. 2 to FIG. 4, refer to corresponding parts in the embodiments in FIG. 2 to FIG. 4, and details are not described herein again. As shown in FIG. 5, the method 500 in this embodiment includes the following steps.

In operation S501, at EM device sends a resource scaling-in request message (e.g., a VNF scaling-in request) to a VNFM device, to request to perform a resource scaling-in on a VNF instance. A resource scaling-in parameter carried in the resource scaling-in request message includes an identifier (vnfInstanceId) of the VNF instance, and may further include one or more of the following parameters: a proportion parameter (scaleStep), a time parameter (timeout), and identification information of a VDU, where the identification information of the VDU includes at least one of a VDU identifier (vduId) of the VDU, a group identifier (vduGroupId) of the VDU, and a type identifier (vduTypeId) of the VDU.

In operation S502, after receiving the resource scaling-in request message, the VNFM device sends a VNF life cycle management operation granting request message (i.e. Granting Request) to an NFVO device, to request granting of resource scaling-in on the VNF instance.

In operation S503, after receiving the operation granting request message, and if determining to grant permission to the VNFM device, the NFVO device sends a VNF life cycle management operation granting response message (Granting Response) to the VNFM device.

In operation S504, the VNFM device sends a resource pre-scaling-in request message (e.g., a VNF pre-scaling-in request) to the EM device based on the granting response message.

In operation S505, the EM device determines, based on the preprocessing request message, a first virtualization container on which the resource pre-scaling-in needs to be performed (that is, one or more virtualization containers on which the resource pre-scaling-in needs to be performed) in the VNF instance. A method for determining the first virtualization container is the same as a method for determining the first virtualization container by the EM device in the method 200.

In operation S506, services hosted in the first virtualization container are migrated.

In operation S507, the EM device sends a preprocessing (pre-scale) acknowledgment message to the VNFM device. The preprocessing acknowledgment message carries an identifier list (IdList) of the first virtualization container on which the preprocessing has been completed, to notify the VNFM device that a resource occupied by the first virtualization container and a resource of a virtual link can be released.

In operation S508, the VNFM device requests, based on the preprocessing acknowledgment message, a VIM device to release the resource occupied by the first virtualization container and the resource of the related virtual link. If not receiving the preprocessing acknowledgment message within a longest wait time stipulated by the time parameter, the VNFM device may send a resource scaling-in operation error message to the NFVO device; or determine a to-be-released virtualization container according to a rule, for example, designate a virtualization container carrying relatively few services as a virtualization container whose resource needs to be released, and directly request the VIM device to release the resource.

In operation S509, the VNFM device sends a response message (response) to the NFVO device, to notify a result of the resource scaling-in.

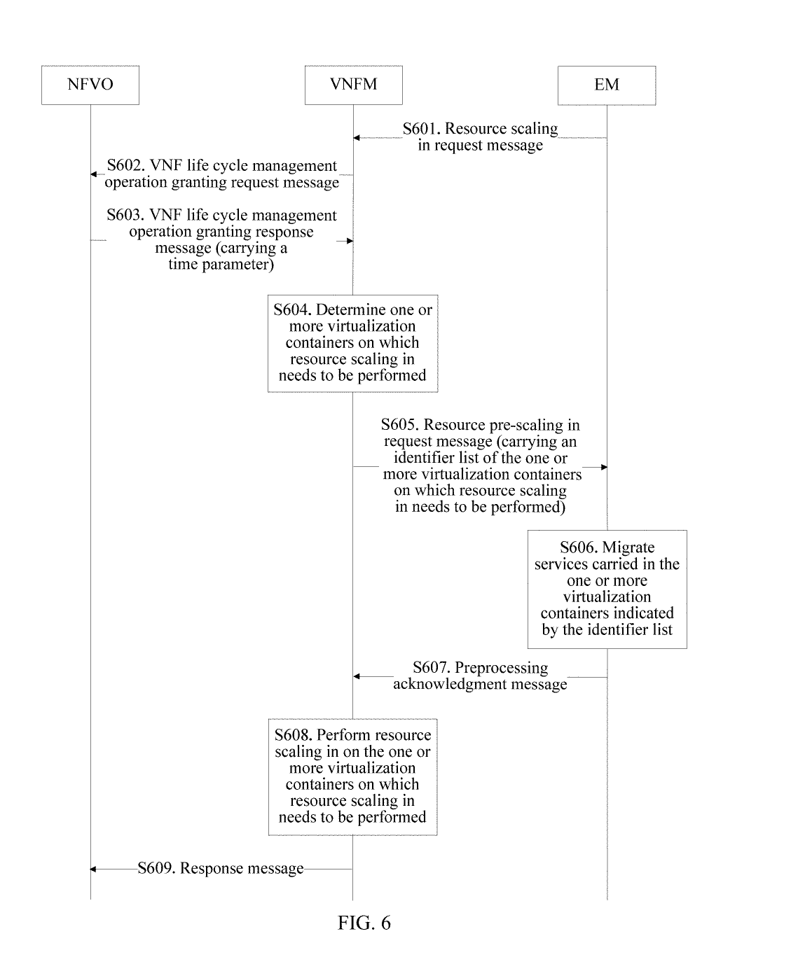

FIG. 6 is a schematic diagram of a VNF resource management method according to still another embodiment of this application. For content in this embodiment the same as those in the embodiments in FIG. 2 to FIG. 6, refer to corresponding parts in the embodiments in FIG. 2 to FIG. 6, and details are not described herein again. As shown in FIG. 6, the method 600 in this embodiment includes the following steps.

In operation S601, an EM device sends a resource scaling-in request message (e.g., a VNF scaling-in request) to a VNFM device, to request to perform a resource scaling-in on a VNF instance. A resource scaling-in parameter carried in the resource scaling-in request message includes an identifier (vnfInstanceId) of the VNF instance, and may further include one or more of the following parameters: a proportion parameter (scaleStep), a time parameter (timeout), and identification information of a VDU, where the identification information of the VDU includes at least one of a VDU identifier (vduId) of the VDU, a group identifier (vduGroupId) of the VDU, and a type identifier (vduTypeId) of the VDU.

In operation S602, after receiving the resource scaling-in request message, the VNFM device sends a VNF life cycle management operation granting request message to an NFVO device, to request granting of resource scaling-in on the VNF instance.

In operation S603, after receiving the operation granting request message, and if determining to grant permission to the VNFM device, the NFVO device sends a VNF life cycle management operation granting response message (Granting Response) to the VNFM device. The granting response message carries the time parameter (timeout).

In operation S604, after receiving the granting response message, the VNFM device determines a first virtualization container (that is, one or more virtualization containers on which the resource pre-scaling-in needs to be performed). A method for determining the first virtualization container is the same as a method for determining the first virtualization container by the EM device in the method 200.

In operation S605, the VNFM device sends a resource pre-scaling-in request message (e.g., a VNF pre-scaling-in request) to the EM device. The resource pre-scaling-in request message includes an identifier list (IdList) of the first virtualization container.

In operation S606, the EM device migrates, based on the preprocessing request message, services hosted in the first virtualization container.

In operation S607, the EM device sends a preprocessing (pre-scale) acknowledgment message to the VNFM device, to notify the VNFM device that a resource occupied by the first virtualization container and a resource of a virtual link can be released.

In operation S608, the VNFM device requests, based on the preprocessing acknowledgment message, a VIM device to release the resource occupied by the one or more virtualization containers and the resource of the related virtual link. If not receiving the preprocessing acknowledgment message within a longest wait time stipulated by the time parameter, the VNFM device may send a resource scaling-in operation error message to the NFVO device, or directly request the VIM device to release the resources.

In operation S609, the VNFM device sends a response message (response) to the NFVO device, to notify a result of the resource scaling-in.

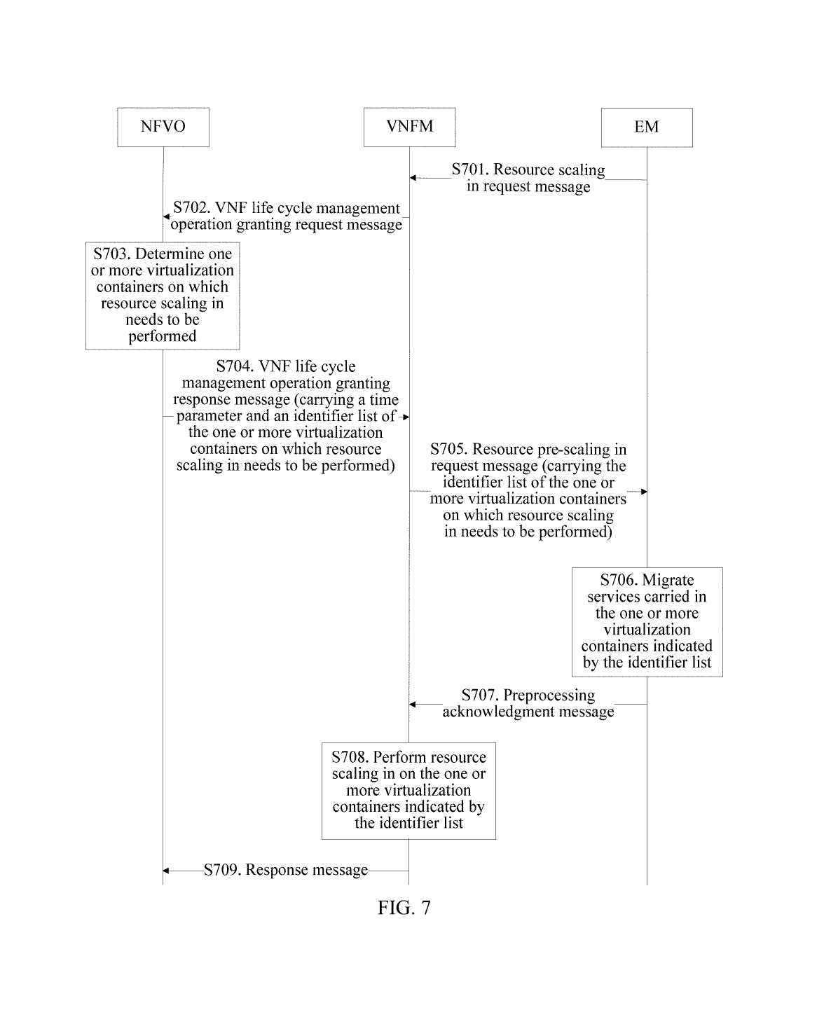

FIG. 7 is a schematic diagram of a VNF resource management method according to still another embodiment of this application. For content in this embodiment the same as those in the embodiments in FIG. 2 to FIG. 6, refer to corresponding parts in the embodiments in FIG. 2 to FIG. 6, and details are not described herein again. As shown in FIG. 7, the method 700 in this embodiment includes the following steps.

In operation S701, an EM device sends a resource scaling-in request message (e.g., a VNF scaling-in request) to a VNFM device, to request to perform a resource scaling-in on a VNF instance. A resource scaling-in parameter carried in the resource scaling-in request message includes an identifier (vnfInstanceId) of the VNF instance, and may further include one or more of the following parameters: a proportion parameter (scaleStep), a time parameter (timeout), and identification information of a VDU, where the identification information of the VDU includes at least one of a VDU identifier (vduId) of the VDU, a group identifier (vduGroupId) of the VDU, and a type identifier (vduTypeId) of the VDU.

In operation S702, after receiving the resource scaling-in request message, the VNFM device sends a VNF life cycle management operation granting request message to an NFVO device, to request granting of resource scaling-in on the VNF instance.

In operation S703, after receiving the operation granting response message, and if determining to grant permission to the VNFM device, the NFVO device may determine a first virtualization container (that is, one or more virtualization containers on which the resource pre-scaling-in needs to be performed). A method for determining the first virtualization container is the same as a method for determining the first virtualization container by the EM device in the method 200.

In operation S704, the NFVO device sends a VNF life cycle management operation granting response message (Granting Response) to the VNFM device. The granting response message carries the time parameter (timeout) and an identifier list (IdList) of the first virtualization container.

In operation S705, after receiving the granting response message, the VNFM device sends a resource pre-scaling-in request message (e.g., a VNF pre-scaling-in request) to the EM device. The resource pre-scaling-in request message carries the identifier list.

In operation S706, the EM device determines, based on the identifier list carried in the preprocessing request message, the one or more virtualization containers on which the resource pre-scaling-in needs to be performed in the VNF instance, and migrates services hosted in the one or more virtualization containers.

In operation S707, the EM device sends a preprocessing (pre-scale) acknowledgment message to the VNFM device, to notify the VNFM device that a resource occupied by the corresponding one or more virtualization containers in the identifier list and a resource of a virtual link can be released.

In operation S708, the VNFM device requests, based on the preprocessing acknowledgment message, a VIM device to release the resource occupied by the one or more virtualization containers and the resource of the related virtual link; and if not receiving the preprocessing acknowledgment message within a longest wait time stipulated by a time parameter, the VNFM device may send a resource scaling-in operation error message to the NFVO device or directly request the VIM device to release the resources.

In operation S709, the VNFM device sends a response message (response) to the NFVO device, to notify a result of the resource scaling-in.

The foregoing embodiments are merely examples, and the embodiments of this application are not limited thereto. In the VNF resource management method provided in the embodiments of this application, preprocessing is performed on the one or more virtualization containers on which the resource scaling-in needs to be performed in the VNF instance, and the services hosted in the one or more virtualization containers are migrated, thereby avoiding, during the resource scaling-in, damage of the services hosted in the one or more virtualization containers corresponding to the VNF instance. In addition, a resource waste caused when the VNFM device performs the resource scaling-in on virtualization containers created based on a plurality of associated VDUs can be avoided through resource scaling-in based on a VDU group or a VDU type.

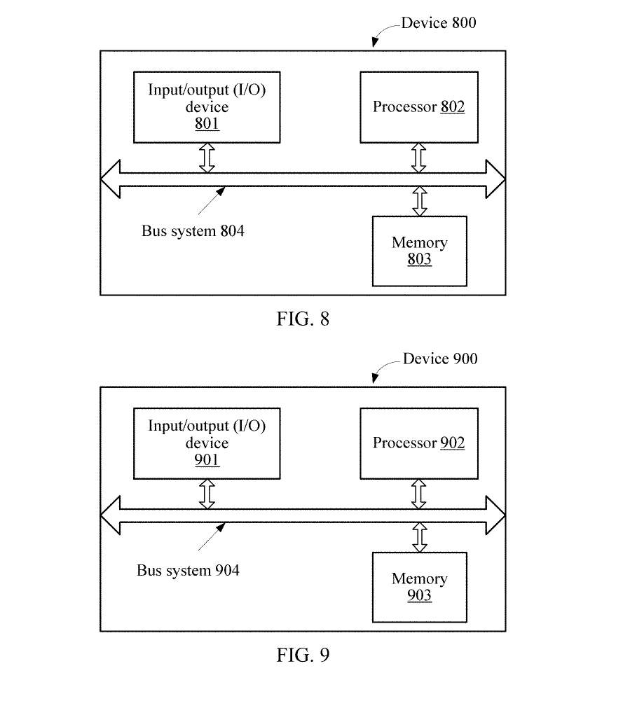

The VNF resource management method according to the embodiments of this application is described in detail above with reference to FIG. 2 to FIG. 7, and a VNF resource management device provided in the embodiments of this application is described in detail below with reference to FIG. 8 to FIG. 10. For VNF resource management devices in embodiments in FIG. 8 to FIG. 10, specifically refer to running processes of VNF resource management devices in FIG. 2 to FIG. 7.

As shown in FIG. 8, an embodiment of this application further provides a VNF resource management device 800. The device 800 may include an input/output (I/O) device 801, a processor 802, a memory 803, and a bus system 804.

The memory 803 is configured to store a program. Specifically, the program may include program code, and the program code includes a computer operation instruction. The memory 803 may be a random access memory (RAM for short), or may be a non-volatile memory, for example, at least one magnetic disk storage. Only one memory is shown in the figure. Certainly, a plurality of memories may alternatively be provided as needed. The memory 803 may alternatively be a memory in the processor 802.

The memory 803 stores the following elements: executable modules or data structures, or a subset thereof, or an extended set thereof:

an operation instruction, including various operation instructions and used to implement various operations; and

an operating system, including various system programs and configured to implement various basic services and process a hardware-based task.

In this embodiment of this application, the processor 802 performs the following operations by invoking the operation instruction (where the operation instruction may be stored in the operating system) stored in the memory 803:

sending, by using the input/output device 801, a preprocessing request message to an EM device, where the preprocessing request message is used to request the EM device to perform a resource pre-scaling-in on a virtualized network function VNF instance, and the resource pre-scaling-in includes migrating services hosted in one or more virtualization containers on which the resource pre-scaling-in needs to be performed; and

performing, by the processor 802, resource scaling-in on the VNF instance after determining that the EM device completes the resource pre-scaling-in.

In the VNF resource management device 800 in this embodiment of this application, the EM device is requested to perform preprocessing on the one or more virtualization containers on which the resource scaling-in needs to be performed in one or more virtualization containers corresponding to the VNF instance and migrate the services hosted in the one or more virtualization containers, to avoid damage of a function of the VNF instance during the resource scaling-in.

The processor 802 controls an operation of the device 800. The processor 802 may also be referred to as a CPU (central processing unit). In a specific application, the components of the device 800 are coupled by using the bus system 804, and the bus system 804 may further include a power bus, a control bus, a status signal bus, and the like in addition to a data bus. However, for clear description, various types of buses in the figure are marked as the bus system 804. For convenience of representation, the bus is represented by using only one thick line in FIG. 8. However, it does not indicate that the bus system 804 has only one bus or only one type of bus.

The methods disclosed in the foregoing embodiments of this application may be applied to the processor 802 or implemented by the processor 802. The processor 802 may be an integrated circuit chip and has a signal processing capability. In an implementation process, steps in the foregoing methods may be completed by using an integrated logic circuit of hardware in the processor 802 or instructions in a form of software in the processor 802. The foregoing processor 802 may be a general purpose processor, a digital signal processor (DSP), an application-specific integrated circuit (ASIC), a field programmable gate array (FPGA) or another programmable logic device, a discrete gate or a transistor logic device, or a discrete hardware component, and may implement or perform the methods, steps, and logical block diagrams disclosed in the embodiments of this application. The general purpose processor may be a microprocessor or the processor may be any conventional processor, or the like. The steps of the methods disclosed in the embodiments of this application may be directly performed and completed by a hardware decoding processor, or may be performed and completed by using a combination of hardware and software modules in the decoding processor. The software module may be located in a mature storage medium in the art, such as a random access memory, a flash memory, a read-only memory, a programmable read-only memory or an electrically erasable programmable memory, or a register. The storage medium is located in the memory 803, and the processor 802 reads information in the memory 803 and completes the steps in the foregoing methods in combination with hardware of the processor 803. To avoid repetition, details are not described herein again.

In one embodiment, performing, by the processor 802, the resource pre-scaling-in on the VNF instance after determining that the EM device completes the resource pre-scaling-in includes:

receiving, by the input/output device 801, a preprocessing acknowledgment message sent by the EM device, where the preprocessing acknowledgment message is used to notify the device 800 that the resource pre-scaling-in has been completed; and performing, by the processor 802, the resource pre-scaling-in on the VNF instance based on the preprocessing acknowledgment message received by the input/output device 801.

In one embodiment, performing, by the processor 802, the resource pre-scaling-in on the VNF instance after determining that the EM device completes the resource pre-scaling-in includes:

Performing, by the processor 802, the resource scaling-in on the VNF instance after a time period elapses after the input/output device 801 sends the preprocessing request message to the EM device.

In one embodiment, before sending the preprocessing request message to the EM device, the input/output device 801 is further configured to receive a resource scaling-in request message sent by a network functions virtualization orchestrator NFVO device, where the resource scaling-in request message includes an identifier list of the one or more virtualization containers on which the resource scaling-in needs to be performed.

The preprocessing request message includes the identifier list of the one or more virtualization containers.

In one embodiment, the resource scaling-in request message further includes a time parameter, and the time parameter is used to determine a time period.

Performing, by the processor 802, the resource scaling-in on the VNF instance after determining that the EM device completes the resource pre-scaling-in includes:

performing, by the processor 802, the resource scaling-in on the VNF instance after the time period elapses after the input/output device 801 sends the preprocessing request message to the EM device.

In one embodiment, the preprocessing request message includes an identifier list of the one or more virtualization containers on which the resource pre-scaling-in needs to be performed, and the identifier list is used to identify the one or more virtualization containers on which the EM device needs to perform a resource pre-scaling-in.

In one embodiment, before sending the preprocessing request message to the EM device, the input/output device 801 is further configured to receive a resource scaling-in request message sent by the EM device, where the resource scaling-in request message includes identification information of a virtualization deployment unit VDU, one or more virtualization containers created based on the VDU identified by the identification information include the one or more virtualization containers identified by the identifier list, and the resource scaling-in request message is used to request the device 800 to perform a resource scaling-in on the one or more virtualization containers created based on the VDU indicated by the identification information in the VNF instance.

In one embodiment, the resource scaling-in request message further includes a quantity parameter or a proportion parameter, where the quantity parameter is used to indicate, to the processor 802, a quantity of virtualization containers on which the resource pre-scaling-in needs to be performed; and the proportion parameter is used to indicate, to the processor 802, a proportion of the one or more virtualization containers on which the resource pre-scaling-in needs to be performed in all the one or more virtualization containers created based on the VDU identified by the identification information.

In one embodiment, after receiving the resource scaling-in request message sent by the EM device and before sending the preprocessing request message to the EM device, the input/output device 801 is further configured to:

send a VNF life cycle management operation granting request message to an NFVO device, where the VNF life cycle management operation granting request message is used to request granting of the resource scaling-in from the NFVO device; and receive a VNF life cycle management operation granting response message sent by the NFVO device.

In one embodiment, the identification information includes at least one of the following information: VDU identification information of the VDU, group identification information of the VDU, and type identification information of the VDU.

The VNF resource management device 800 according to this embodiment of this application may correspond to the VNFM device in the VNF resource management method in the embodiments of this application, and the foregoing and other operations and/or functions of the modules in the device 800 are respectively used to implement corresponding procedures of the steps performed by the VNFM device in the method 200 to the method 700. For brevity, details are not described herein again.

Therefore, in the VNF resource management device 800 provided in this embodiment of this application, preprocessing is performed on the one or more virtualization containers on which the resource scaling-in needs to be performed in the one or more virtualization containers corresponding to the VNF instance, and the services running in the one or more virtualization containers are migrated, to avoid, during the resource scaling-in, damage of services hosted in the VNF instance. In addition, a resource waste caused when a resource scaling-in operation is performed on the VNF instance can be avoided through a resource scaling-in operation based on a VDU group or a VDU type.

As shown in FIG. 9, an embodiment of this application further provides a VNF resource management device 900. The device 900 may include an input/output (I/O) device 901, a processor 902, a memory 903, and a bus system 904.

The memory 903 is configured to store a program. Specifically, the program may include program code, and the program code includes a computer operation instruction. The memory 903 may be a random access memory (RAM for short), or may be a non-volatile memory, for example, at least one magnetic disk storage. Only one memory is shown in the figure. Certainly, a plurality of memories may alternatively be provided as needed. The memory 903 may alternatively be a memory in the processor 902.

The memory 903 stores the following elements: executable modules or data structures, or a subset thereof, or an extended set thereof:

an operation instruction, including various operation instructions and used to implement various operations; and

an operating system, including various system programs and configured to implement various basic services and process a hardware-based task.

In this embodiment of this application, the processor 902 performs the following operations by invoking the operation instruction (where the operation instruction may be stored in the operating system) stored in the memory 903:

receiving, by using the input/output device 901, a preprocessing request message sent by a virtualized network function manager VNFM device, where the preprocessing request message is used to request the device 900 to perform a resource pre-scaling-in on a virtualized network function VNF instance;

determining, by the processor 902, a first virtualization container based on the preprocessing request message received by the input/output device 901, where the first virtualization container is one or more virtualization containers on which the resource pre-scaling-in needs to be performed in one or more virtualization containers corresponding to the VNF instance; and

migrating, by the processor 902, services hosted in the first virtualization container.

In the VNF resource management device 900 in this embodiment of this application, preprocessing is performed on the one or more virtualization containers on which the resource scaling-in needs to be performed in the one or more virtualization containers corresponding to the VNF instance, and the services hosted in the one or more virtualization containers are migrated, to ensure that a function of the VNF instance is not damaged during the resource scaling-in.

The processor 902 controls an operation of the device 900. The processor 902 may also be referred to as a CPU (central processing unit). The memory 903 may include a read-only memory and a random access memory, and provide an instruction and data to the processor 902. A part of the memory 903 may further include a non-volatile random access memory (NVRAM). In a specific application, the components of the device 900 are coupled by using the bus system 904, and the bus system 904 may further include a power bus, a control bus, a status signal bus, and the like in addition to a data bus. However, for clear description, various types of buses in the figure are marked as the bus system 904. For convenience of representation, the bus is represented by using only one thick line in FIG. 9. However, it does not indicate that the bus system 904 has only one bus or only one type of bus.

The methods disclosed in the foregoing embodiments of this application may be applied to the processor 902 or implemented by the processor 902. The processor 902 may be an integrated circuit chip and has a signal processing capability. In an implementation process, steps in the foregoing methods may be completed by using an integrated logic circuit of hardware in the processor 902 or instructions in a form of software in the processor 902. The foregoing processor 902 may be a general purpose processor, a digital signal processor (DSP), an application-specific integrated circuit (ASIC), a field programmable gate array (FPGA) or another programmable logic device, a discrete gate or a transistor logic device, or a discrete hardware component, and may implement or perform the methods, steps, and logical block diagrams disclosed in the embodiments of this application. The general purpose processor may be a microprocessor or the processor may be any conventional processor, or the like. Steps of the methods disclosed in the embodiments of this application may be directly performed and completed by a hardware decoding processor, or may be performed and completed by using a combination of hardware and software modules in the decoding processor. The software module may be located in a mature storage medium in the art, such as a random access memory, a flash memory, a read-only memory, a programmable read-only memory or an electrically erasable programmable memory, or a register. The storage medium is located in the memory 903, and the processor 902 reads information in the memory 903 and completes the steps in the foregoing methods in combination with hardware of the processor 902. To avoid repetition, details are not described herein again.

In one embodiment, the preprocessing request message further includes identification information of a virtualization deployment unit VDU.

The determining, by the processor 902, a first virtualization container based on the preprocessing request message includes:

determining, by the processor 902 according to the identification information, the first virtualization container in one or more virtualization containers created based on the VDU identified by the identification information.

Optionally, the determining, by the processor 902, the first virtualization container in one or more virtualization containers created based on the VDU identified by the identification information includes:

determining, by the processor 902 based on a service volume of services hosted in the one or more virtualization containers and/or importance of the services hosted in the one or more virtualization containers, the first virtualization container in the one or more virtualization containers created based on the VDU identified by the identification information.

In one embodiment, the preprocessing request message further includes a quantity parameter or a proportion parameter, where

the quantity parameter is used to indicate, to the processor 902, a quantity of virtualization containers on which the resource pre-scaling-in needs to be performed; and

the proportion parameter is used to indicate, to the processor 902, a proportion of the one or more virtualization containers on which the resource pre-scaling-in needs to be performed in all the one or more virtualization containers created based on the VDU indicated by the identification information.

In one embodiment, the preprocessing request message further includes an identifier list of the one or more virtualization containers on which the resource pre-scaling-in needs to be performed.

The determining, by the processor 902, a first virtualization container based on the preprocessing request message includes:

determining, by the processor 902, that the one or more virtualization containers identified by the identifier list are the first virtualization container.

Optionally, before receiving the preprocessing request message sent by the VNFM device, the input/output device 901 is further configured to:

send a resource scaling-in request message to the VNFM device, where the resource scaling-in request message includes identification information of a VDU, one or more virtualization containers created based on the VDU indicated by the identification information include the one or more virtualization containers indicated by the identifier list, and the resource scaling-in request message is used to request the VNFM device to perform a resource scaling-in on the one or more virtualization containers created based on the VDU indicated by the identification information.

In one embodiment, the resource scaling-in request message further includes a quantity parameter or a proportion parameter, where

the quantity parameter is used to indicate, to the VNFM device, a quantity of virtualization containers on which the resource pre-scaling-in needs to be performed; and

the proportion parameter is used to indicate, to the VNFM device, a proportion of the one or more virtualization containers on which the resource pre-scaling-in needs to be performed in all the one or more virtualization containers created based on the VDU identified by the identification information.

In one embodiment, the identification information of the VDU includes at least one of the following information: VDU identification information of the VDU, group identification information of the VDU, and type identification information of the VDU.

In one embodiment, after the processor 902 migrates the services hosted in the first virtualization container, the input/output device 901 is further configured to:

send a preprocessing acknowledgment message to the VNFM device, where the preprocessing acknowledgment message is used to notify the VNFM device that the resource pre-scaling-in has been completed.

The VNF resource management device 900 according to this embodiment of this application may correspond to the EM device in the VNF resource management method in the embodiments of this application, and the foregoing and other operations and/or functions of the modules in the device 900 are respectively used to implement corresponding procedures of the steps performed by the EM device in the method 200 to the method 700. For brevity, details are not described herein again.

Therefore, in the VNF resource management device 900 provided in this embodiment of this application, preprocessing is performed on the one or more virtualization containers on which the resource scaling-in needs to be performed in the one or more virtualization containers corresponding to the VNF instance, and the services hosted in the one or more virtualization containers are migrated, to avoid, during the resource scaling-in, damage of services hosted in the VNF instance. In addition, a resource waste caused when a resource scaling-in operation is performed on the VNF instance can be avoided through a resource scaling-in operation based on a VDU group or a VDU type.

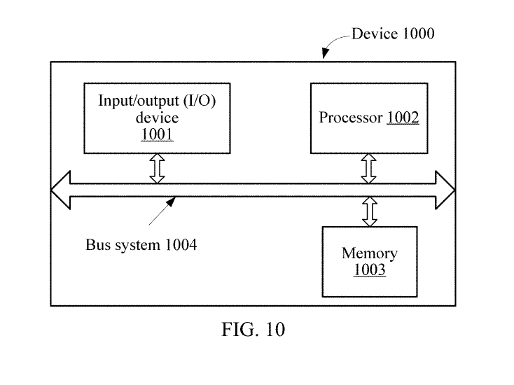

As shown in FIG. 10, an embodiment of this application further provides a VNF resource management device 1000. The device 1000 may include an input/output (I/O) device 1001, a processor 1002, a memory 1003, and a bus system 1004.

The memory 1003 is configured to store a program. Specifically, the program may include program code, and the program code includes a computer operation instruction. The memory 1003 may be a random access memory (RAM for short), or may be a non-volatile memory, for example, at least one magnetic disk storage. Only one memory is shown in the figure. Certainly, a plurality of memories may be provided as needed. The memory 1003 may alternatively be a memory in the processor 1002.

The memory 1003 stores the following elements, executable modules or data structures, or a subset thereof, or an extended set thereof:

an operation instruction, including various operation instructions and used to implement various operations; and

an operating system, including various system programs and configured to implement various basic services and process a hardware-based task.

In this embodiment of this application, the processor 1002 performs the following operations by invoking the operation instruction (where the operation instruction may be stored in the operating system) stored in the memory 1003:

receiving, by using the input/output device 1001, a preprocessing request message sent by a virtualized network function manager VNFM device, where the preprocessing request message is used to request the device 1000 to perform a resource pre-scaling-in on a virtualized network function VNF instance;

determining, by the processor 1002, an identifier list of one or more virtualization containers on which the resource pre-scaling-in needs to be performed in one or more virtualization containers corresponding to the virtualized network function VNF instance; and sending, by the input/output device 1001 to the virtualized network function manager VNFM device, the identifier list determined by the processor 1002, so that the VNFM device requests an EM device to perform a resource pre-scaling-in on the one or more virtualization containers identified by the identifier list.

In the VNF resource management device 1000 in this embodiment of this application, preprocessing is performed on the one or more virtualization containers on which the resource scaling-in needs to be performed in the one or more virtualization containers corresponding to the VNF instance and the services hosted in the one or more virtualization containers are migrated, to ensure that a function of the VNF instance is not damaged during the resource scaling-in.

The processor 1002 controls an operation of the device 1000. The processor 1002 may also be referred to as a CPU (central processing unit). The memory 1003 may include a read-only memory and a random access memory, and provide an instruction and data to the processor 1002. A part of the memory 1003 may further include a non-volatile random access memory (NVRAM). In a specific application, the components of the device 1000 are coupled by using the bus system 1004, and the bus system 1004 may further include a power bus, a control bus, a status signal bus, and the like in addition to a data bus. However, for clear description, various types of buses in the figure are marked as the bus system 1004. For convenience of representation, the bus is represented by using only one thick line in FIG. 10. However, it does not indicate that the bus system 1004 has only one bus or only one type of bus.

The methods disclosed in the foregoing embodiments of this application may be applied to the processor 1002 or implemented by the processor 1002. The processor 1002 may be an integrated circuit chip and has a signal processing capability. In an implementation process, steps in the foregoing methods may be completed by using an integrated logic circuit of hardware in the processor 1002 or instructions in a form of software in the processor 1010. The foregoing processor 1002 may be a general purpose processor, a digital signal processor (DSP), an application-specific integrated circuit (ASIC), a field programmable gate array (FPGA) or another programmable logic device, a discrete gate or a transistor logic device, or a discrete hardware component, and may implement or perform the methods, steps, and logical block diagrams disclosed in the embodiments of this application. The general purpose processor may be a microprocessor or the processor may be any conventional processor, or the like. Steps of the methods disclosed in the embodiments of this application may be directly performed and completed by a hardware decoding processor, or may be performed and completed by using a combination of hardware and software modules in the decoding processor. The software module may be located in a mature storage medium in the art, such as a random access memory, a flash memory, a read-only memory, a programmable read-only memory or an electrically erasable programmable memory, or a register. The storage medium is located in the memory 1003, and the processor 1002 reads information in the memory 1003 and completes the steps in the foregoing methods in combination with hardware of the processor. To avoid repetition, details are not described herein again.

In one embodiment, before the processor 1002 determines the identifier list, the input/output device 1001 is further configured to:

receive a VNF life cycle management operation granting request message sent by the VNFM device, where the VNF life cycle management operation granting request message is used to request granting of resource scaling-in from the processor 1002, and the resource scaling-in is resource scaling-in performed by the VNFM device on the one or more virtualization containers corresponding to the VNF instance; and

send a VNF life cycle management operation granting response message to the VNFM device, where the VNF life cycle management operation granting response message is used for the granting of the resource scaling-in.

The sending, by the input/output device 1001, the identifier list to the VNFM device includes:

sending, by the input/output device 1001, the VNF life cycle management operation granting response message including the identifier list to the VNFM device.

In one embodiment, after the processor 1002 determines the identifier list, the input/output device 1001 is further configured to:

send a resource scaling-in request message to the VNFM device, where the resource scaling-in request message is used to request the VNFM device to perform a resource scaling-in on the one or more virtualization containers corresponding to the VNF instance.

The sending, by the input/output device 1001, the identifier list to the VNFM device includes:

sending, by the input/output device 1001, the resource scaling-in request message including the identifier list to the VNFM device.

In one embodiment, the resource scaling-in request message further includes a time parameter, where the time parameter is used to instruct the VNFM device to perform, after the VNFM device sends the preprocessing request message to the EM device and after a time period indicated by the time parameter, the resource scaling-in on the one or more virtualization containers corresponding to the VNF instance.

The VNF resource management device 1000 according to this embodiment of this application may correspond to the NFVO device in the VNF resource management method in the embodiments of this application, and the foregoing and other operations and/or functions of the modules in the device 1000 are respectively used to implement corresponding procedures of the steps performed by the NFVO device in the method 200 to the method 700. For brevity, details are not described herein again.

Therefore, in the VNF resource management device 1000 provided in this embodiment of this application, preprocessing is performed on the one or more virtualization containers on which the resource scaling-in needs to be performed in the one or more virtualization containers corresponding to the VNF instance, and the services hosted in the one or more virtualization containers are migrated, to avoid, during the resource scaling-in, damage of services hosted in the VNF instance. In addition, a resource waste caused when a resource scaling-in operation is performed on the VNF instance can be avoided through a resource scaling-in operation based on a VDU group or a VDU type.

Sequence numbers of the processes do not mean execution sequences in various embodiments of this application. The execution sequences of the processes should be determined based on functions and internal logic of the processes, and should not constitute any limitation on implementation processes of the embodiments of this application.

In addition, the term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between associated objects.

It should be understood that in the embodiments of this application, “B corresponding to A” indicates that B is associated with A, and B may be determined based on A. However, it should also be understood that determining B based on A does not mean that B is determined based on A only, and B may also be determined based on A and/or other information.

A person of ordinary skill in the art may be aware that, the units and algorithm steps in the examples described with reference to the embodiments disclosed herein may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communications connections may be implemented through some interfaces, indirect couplings or communication connections between the apparatuses or units, electrical connections, mechanical connections, or connections in other forms.

The units described as separate parts may or may not be physically separate, and parts displayed as units may or may not be physical units, may be located in one position, or may be distributed on a plurality of network units. Some or all of the units may be selected based on actual needs to achieve the objectives of the solutions of the embodiments of this application.

In addition, the function units in the embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this application essentially, or the part contributing to the prior art, or all or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of this application. The foregoing storage medium includes: any medium that can store program code, such as a USB flash drive, a removable hard disk, a read-only memory (ROM), a random access memory (RAM), a magnetic disk, or an optical disc.

To make the application document brief and clear, technical features and descriptions in one of the foregoing embodiments may be considered to be applicable to other embodiments, and details are not described in the other embodiments.

The foregoing descriptions are merely specific implementations of this application, but are not intended to limit the protection scope of this application. Any equivalent modification or replacement readily figured out by a person skilled in the art within the technical scope disclosed in this application shall fall within the protection scope of this application. Therefore, the protection scope of this application shall be subject to the protection scope of the claims.

1. A virtualized network function resource management method, comprising:
sending, by a virtualized network function manager (VNFM) device, a preprocessing request message to an element manager (EM) device, wherein the preprocessing request message is used to request the EM device to perform a resource pre-scaling-in on a virtualized network function (VNF) instance, and the resource pre-scaling-in comprises migrating one or more services hosted in a virtualization container on which the resource pre-scaling-in is to be performed; and
performing, by the VNFM device, the resource scaling-in on the VNF instance after determining that the EM device completes the resource pre-scaling-in.

2. The method according to claim 1, wherein performing, by the VNFM device, the resource scaling-in on the VNF instance after determining that the EM device completes the resource pre-scaling-in comprises:
receiving, by the VNFM device, a preprocessing acknowledgment message sent by the EM device, wherein the preprocessing acknowledgment message is used to notify the VNFM device that the resource pre-scaling-in has been completed; and
performing, by the VNFM device, the resource scaling-in on the VNF instance based on the preprocessing acknowledgment message.

3. The method according to claim 1, wherein performing, by the VNFM device, the resource scaling-in on the VNF instance after determining that the EM device completes the resource pre-scaling-in comprises:
performing, by the VNFM device, the resource scaling-in on the VNF instance after a time period elapses after the VNFM device sends the preprocessing request message to the EM device.

4. The method according to claim 1, further comprising:
before sending, by a VNFM device, the preprocessing request message to the EM device, receiving, by the VNFM device, a resource scaling-in request message sent by a network functions virtualization orchestrator (NFVO) device, wherein the resource scaling-in request message comprises an identifier list of a virtualization container on which the resource pre-scaling-in is to be performed, wherein the preprocessing request message comprises the identifier list of the virtualization container.

5. The method according to claim 4,
wherein the resource scaling-in request message further comprises a time parameter that is used to determine a time period; and
wherein performing, by the VNFM device, the resource scaling-in on the VNF instance after determining that the EM device completes the resource pre-scaling-in comprises:
performing, by the VNFM device, the resource scaling-in on the VNF instance after the time period elapses after the VNFM device sends the preprocessing request message to the EM device.

6. The method according to claim 1, wherein the preprocessing request message comprises an identifier list of the virtualization container on which the resource pre-scaling-in is to be performed, and wherein the identifier list is used to identify the virtualization container on which the resource pre-scaling-in is to be performed.

7. The method according to claim 6, further comprising:
before sending, by the VNFM device, the preprocessing request message to the EM device, receiving, by the VNFM device, a resource scaling-in request message sent by the EM device,
wherein the resource scaling-in request message comprises identification information of a virtualization deployment unit (VDU), and
wherein a virtualization container created based on the VDU identified by the identification information is the virtualization container identified by the identifier list.

8. The method according to claim 7, wherein the resource scaling-in request message further comprises a quantity parameter or a proportion parameter,
wherein the quantity parameter is used to indicate, to the VNFM device, a quantity of virtualization containers on which the resource pre-scaling-in is to be performed; and
wherein the proportion parameter is used to indicate, to the VNFM device, a proportion of the virtualization containers on which the resource pre-scaling-in is to be performed in one or more virtualization containers created based on the VDU identified by the identification information.

9. The method according to claim 7, further comprising
after receiving, by the VNFM device, the resource scaling-in request message sent by the EM device and before sending, by the VNFM device, the preprocessing request message to the EM device, sending, by the VNFM device, a VNF life cycle management operation granting request message to an NFVO device, wherein the VNF life cycle management operation granting request message is used to request granting of the resource scaling-in from the NFVO device; and
receiving, by the VNFM device, a VNF life cycle management operation granting response message sent by the NFVO device.

10. The method according to claim 7, wherein the identification information comprises at least one of the following information: VDU identification information of the VDU, group identification information of the VDU, and type identification information of the VDU.

11. A virtualized network function resource management method, comprising:
receiving, by an element manager (EM) device, a preprocessing request message sent by a virtualized network function manager (VNFM) device, wherein the preprocessing request message is used to request the EM device to perform a resource pre-scaling-in on a virtualized network function (VNF) instance;
determining, by the EM device, a first virtualization container based on the preprocessing request message, wherein the first virtualization container is a virtualization container on which the resource pre-scaling-in is to be performed in a virtualization container corresponding to the VNF instance; and
migrating, by the EM device, one or more services hosted in the first virtualization container.

12. The method according to claim 11,
wherein the preprocessing request message further comprises identification information of a virtualization deployment unit (VDU); and
wherein determining, by the EM device, the first virtualization container based on the preprocessing request message comprises:
determining, by the EM device according to the identification information, a virtualization container from one or more virtualization containers created based on the VDU identified by the identification information.

13. The method according to claim 12, wherein determining, by the EM device, the first virtualization container from the one or more virtualization containers created based on the VDU identified by the identification information comprises:
determining, by the EM device based on at least one of a service volume of one or more services hosted in the one or more virtualization containers and importance of the one or more services hosted in the one or more virtualization containers.

14. The method according to claim 12,
wherein the preprocessing request message further comprises a quantity parameter or a proportion parameter;
wherein the quantity parameter is used to indicate, to the EM device, a quantity of virtualization containers on which the resource pre-scaling-in is to be performed; and
wherein the proportion parameter is used to indicate, to the EM device, a proportion of the virtualization container on which the resource pre-scaling-in needs to be performed in all the virtualization container created based on the VDU identified by the identification information.

15. A virtualized network function resource management device, comprising:
an input/output device, configured to send a preprocessing request message to an element manager (EM) device, wherein the preprocessing request message is used to request the EM device to perform a resource pre-scaling-in on a virtualized network function (VNF) instance, and wherein the resource pre-scaling-in comprises migrating one or more services hosted in a virtualization container on which the resource pre-scaling-in is to be performed; and
a processor, configured to perform the resource scaling-in on the VNF instance after determining that the EM device completes the resource pre-scaling-in.

16. The device according to claim 15,
wherein the input/output device is further configured to receive a preprocessing acknowledgment message sent by the EM device, wherein the preprocessing acknowledgment message is used to notify the virtualized network function resource management device that the resource pre-scaling-in has been completed; and
wherein the processor is further configured to perform the resource pre-scaling-in on the VNF instance based on the preprocessing acknowledgment message received by the input/output device.

17. The device according to claim 15, wherein
the processor is further configured to perform the resource scaling-in on the VNF instance after a time period elapses after the input/output device sends the preprocessing request message to the EM device.

18. The device according to claim 15,
wherein the input/output device is further configured to receive a resource scaling-in request message sent by a network functions virtualization orchestrator (NFVO) device, wherein the resource scaling-in request message comprises an identifier list of the virtualization container on which the resource pre-scaling-in is to be performed; and
wherein the preprocessing request message comprises the identifier list of the virtualization container.

19. The device according to claim 18,
wherein the resource scaling-in request message further comprises a time parameter, and the time parameter is used to determine a time period; and
wherein the processor is further configured to perform the resource scaling-in on the VNF instance after the time period elapses after the input/output device sends the preprocessing request message to the EM device.

20. The device according to claim 15,
wherein the preprocessing request message comprises an identifier list of the virtualization container on which the resource pre-scaling-in is to be performed; and
wherein the identifier list is used to identify the virtualization container on which the resource pre-scaling-in is to be performed.
